(19) United States
(12) Patent Application Publication
(10) Pub. No.: US 2009/0237293 A1
(43) Pub. Date: Sep. 24, 2009

(54) Recognition system for vehicle

(75) Inventor: Yasushi Sakuma, Chita-gun (JP)

Correspondence Address: HARNESS, DICKEY & PIERCE, P.L.C., P.O. BOX 828, BLOOMFIELD HILLS, MI, 48303, US

(73) Assignee: DENSO CORPORATION, Kariya-city (JP)

(21) Appl. No.: 12/381,934

(22) Filed: Mar. 18, 2009

(30) Foreign Application Priority Data
Mar. 21, 2008 (JP) 2008-074043

(51) Int. Cl. G08G 1/16; G01S 13/06

(52) U.S. Cl. 342/146

(57) ABSTRACT

In a recognition system for a vehicle, forward vehicle information and infrastructural information are checked together and with respect to information that can be considered to pertain to one and the same vehicle. Pieces of information on position and speed are averaged to acquire the information of the vehicle. Pieces of information that can be considered to pertain to one and the same vehicle are searched for and integrated into one. Further, estimated values of speed and position in the future are corrected using traveling information. Then identical lane probability and collision time are estimated, and information of the subject vehicle is transmitted to a vehicle on a potential collision course.

### CROSS REFERENCE TO RELATED APPLICATION

This application is based on and incorporates herein by reference Japanese Patent Application No. 2008-74043 filed on Mar. 21, 2008.

### FIELD OF THE INVENTION

The present invention relates to a system that recognizes objects.

### BACKGROUND OF THE INVENTION

In some conventional systems, a subject vehicle acquires the position information of the other vehicle near the subject vehicle from the communication device equipped in the other vehicle and notify the user, as disclosed in US 2005/0225457 A (JP 2005-301581 A). This system is so configured that each vehicle measures its own position based on information acquired from GPS (Global Positioning System) and the position information acquired by this measurement is utilized.

In this system information acquired from the other vehicle usually includes an error, and hence uses in which the information can be utilized are limited. This is because information acquired by checking together pieces of position information individually measured includes a large error. Information itself acquired from GPS also includes error. These errors are not negligible to be disregarded.

### SUMMARY OF THE INVENTION

It is therefore an object of the invention to provide a recognition system, wherein the accuracy of position information transmitted from the other communication device is enhanced and the position of the communication device can be precisely recognized.

According to one aspect of the present invention, a recognition system comprises a communication device and a recognition device. The communication device has a first communicating unit configured to wirelessly transmit information on present position thereof to a surrounding area. The recognition device has a second communicating unit configured to receive position information transmitted from the communication device. The recognition device has an analyzing section, a position acquiring section, a recognizing section and a position correcting section.

The analyzing section is configured to radiate a radar wave and determine positions of objects based on result of reception of reflected waves that are reflected by the objects. The position acquiring section is configured to acquire information of present position of the recognition device. The recognizing section is configured to recognize as a nearby device an object among the objects whose position has been determined by the analyzing means based on result of analysis by the analyzing means, the position information received by the second communicating means, and result of acquisition by the position acquiring means. The position correcting section is configured to correct the position information of the nearby device received by the second communicating means based on result of acquisition by the position acquiring means and result of analysis by the analyzing means.

### BRIEF DESCRIPTION OF THE DRAWINGS

The above and other objects, features and advantage of the present invention will become more apparent from the following detailed description made with reference to the accompanying drawings. In the drawings:

FIG. 1 is a block diagram illustrating an inter-vehicle communication device to which the invention is applied;

FIG. 2 is a schematic diagram illustrating communications among the inter-vehicle communication devices equipped in the vehicles;

FIG. 3 is a table showing a detailed example of infrastructural information;

FIG. 4 is a flowchart illustrating processing of generating and transmitting infrastructural information;

FIG. 5 is a flowchart illustrating processing of receiving and updating infrastructural information;

FIG. 6 is a graph representing forward vehicle information;

FIG. 7 is a functional block diagram illustrating acquisition of forward vehicle information;

FIG. 8 is a flowchart illustrating transmission processing;

FIG. 9 is a schematic diagram illustrating cause of erroneous recognition by information from a radar;

FIG. 10 is a flowchart illustrating correction processing;

FIG. 11 is a schematic diagram illustrating correction of a future position; and

FIG. 12 is a flowchart illustrating notification processing.

### DETAILED DESCRIPTION OF THE PREFERRED EMBODIMENTS

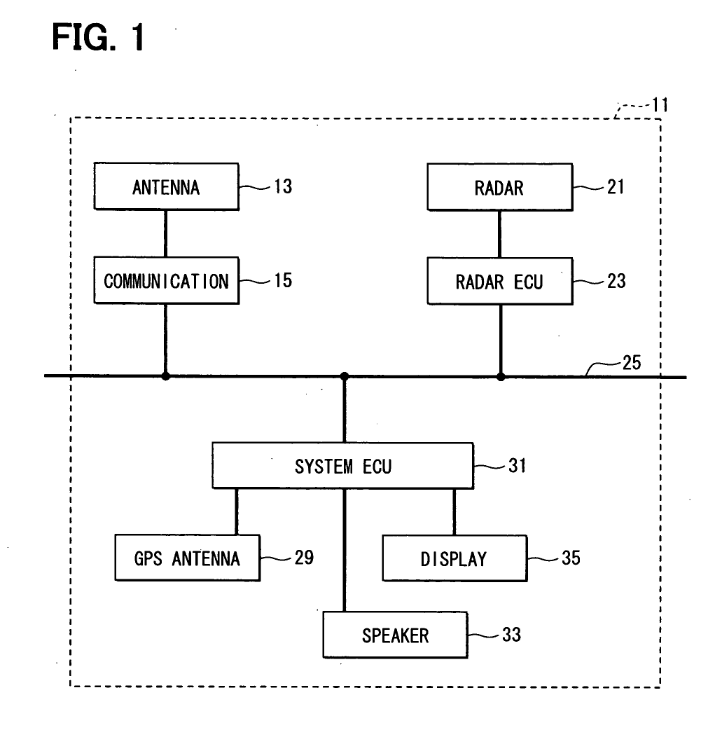

Referring first to FIG. 1, an inter-vehicle communication device 11 equipped and used in a vehicle includes a communication antenna 13, a communication control ECU 15, a radar 21, a radar control ECU 23, a vehicle LAN 25, a GPS antenna 29, a system control ECU 31, a speaker 33 and a display 35. The antenna 13 and ECU 15 operate as first communicating means mounted in one vehicle and second communicating means mounted in another vehicle.

The communication antenna 13 transmits and receives radio waves for communication with other inter-vehicle communication devices 11 and is controlled by the communication control ECU 15. From the communication antenna 13, radio waves with a range of a few tens of meters to a few hundreds of meters are outputted.

The communication control ECU 15 generates transmission signals based on data received through the vehicle LAN 25 and causes the communication antenna 13 to transmit the signals as radio waves. The communication control ECU thereby transmits data to the inter-vehicle communication devices 11 equipped in other vehicles. Further, the communication control ECU 15 restores data to original state based on radio waves sent from the inter-vehicle communication device 11 equipped in another vehicle and received by the communication antenna 13 and outputs the data to the vehicle LAN 25.

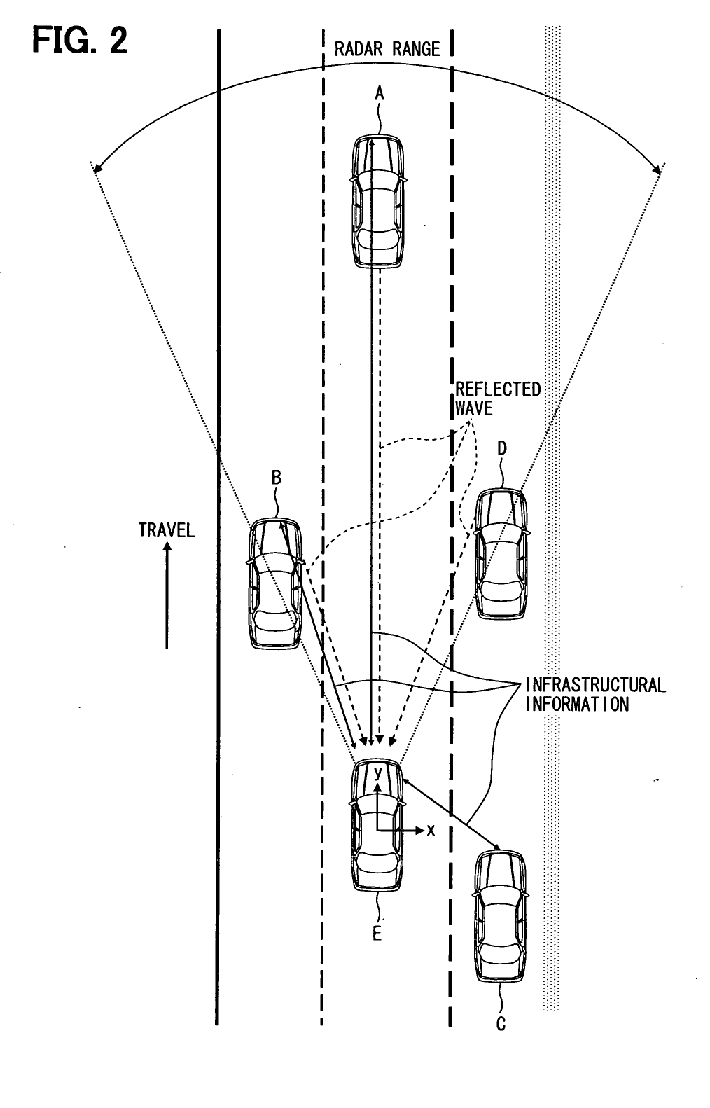

The radar 21 outputs a millimeter wave in a forward area ahead of the vehicle equipped with the inter-vehicle communication device 11 and receives a reflected wave from an object present ahead of the vehicle (FIG. 2).

The radar control ECU 23 controls the radar 21. In addition, the radar control ECU 23 measures the distance to the object present ahead of the vehicle based on the time it takes for the millimeter wave outputted by the radar 21 to come back as a reflected wave. The radar control ECU 23 outputs information on the result of the measurement to the vehicle LAN 25.

The GPS antenna 29 receives radio waves from GPS satellites and outputs received signals to the system control ECU 31. The speaker 33 outputs various warning sounds and voices. The display 35 is a liquid crystal display, an organic EL display, or the like and displays images.

The system control ECU 31 calculates the position of the subject vehicle from an output signal from the GPS antenna 29. In addition, the system control ECU 31 acquires various information through the vehicle LAN 25 and further outputs information for controlling the ECUs connected to the vehicle LAN 25. Further, the system control ECU 31 controls the speaker 33 and the display 35.

In addition, the system control ECU 31 acquires infrastructural information (described in detail later) related to the subject vehicle and transmits the acquired infrastructural information to the surrounding area through the communication antenna 13.

FIG. 2 illustrates the way vehicles equipped with the inter-vehicle communication device 11 travel. Specifically it depicts the way vehicle A, vehicle B, vehicle C, vehicle D and vehicle E are traveling on a triple-lane road. In this example, the vehicles are traveling from bottom to top of the drawing sheet and vehicle A, vehicle B, vehicle C and vehicle E are equipped with the inter-vehicle communication device 11, respectively. Vehicle D is not equipped with the inter-vehicle communication device 11. FIG. 2 shows the way pieces of the infrastructural information of vehicle A, vehicle B, and vehicle C are transmitted toward vehicle E on the above assumption.

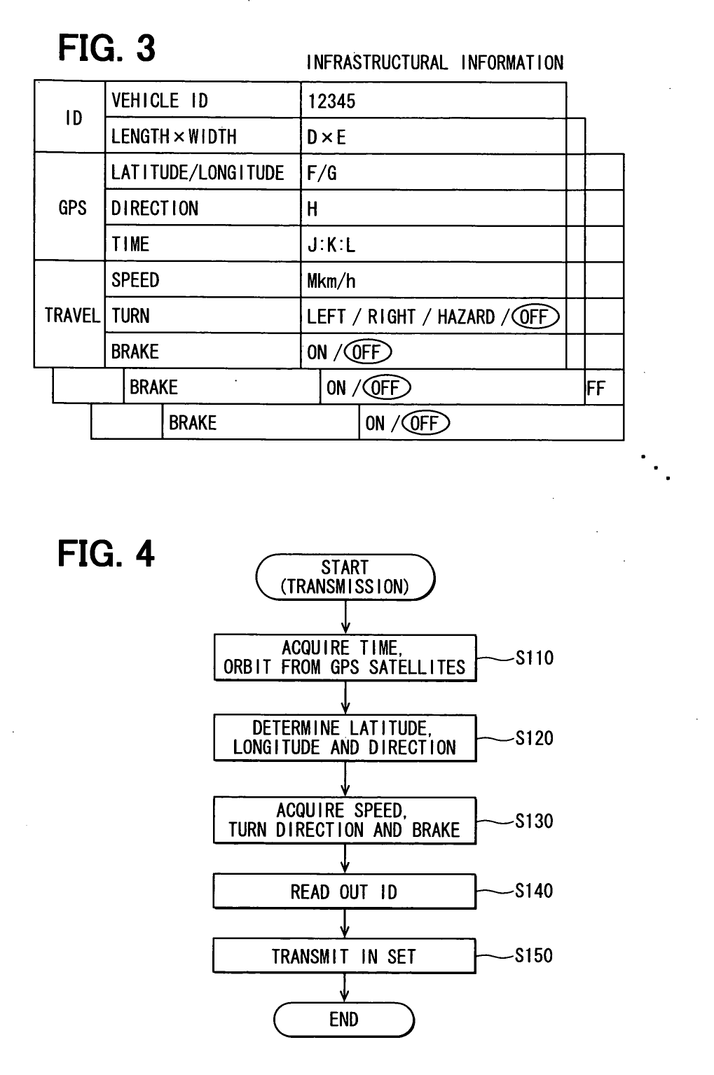

Exemplary infrastructural information are shown in to FIG. 3. The tables illustrated in FIG. 3 are detailed examples of infrastructural information. The infrastructure cited here is slightly different from the common meaning thereof. Here, the inter-vehicle communication devices 11 other than the inter-vehicle communication device 11 equipped in the subject vehicle are defined as infrastructure. Information transmitted from the other inter-vehicle communication devices is designated as infrastructural information. Infrastructural information about the subject vehicle collected for transmission to other vehicles may be used for the subject vehicle. This information is also designated as infrastructural information though not transmitted from other vehicles.

As illustrated in FIG. 3, infrastructural information includes identification (ID) information specific to each vehicle, GPS information acquired through the GPS antenna 29, and travel information acquired through the vehicle IAN 25.

The ID information includes vehicle ID specific to each vehicle and the entire length×the entire width of the vehicle. These pieces of information are stored beforehand in the system control ECU 31 during designing.

The GPS information includes latitude and longitude, traveling direction, and time. These pieces of information are derived by the system control ECU 31 based on information acquired from GPS satellites. Incidentally, 0 degree of traveling direction indicates true north and one turn is equivalent to 360 degrees. The value of traveling direction is increased as it turns clockwise.

The traveling information includes information on speed, turn signal flasher, and brake. Information on speed indicates the speed of the vehicle and is represented by scalar values. “Speed” cited in the following description is represented by a vector. Information on turn signal flasher takes four pattern values, OFF, right, left and hazard. “OFF” represents that no turn signal flasher is in operation; “right (left)” represents that the right (left) turn signal flasher is in operation; and “hazard” represents that both turn signal flashers are in operation. Brake information indicates whether or not the foot brake or the parking brake is in operation.

The system control ECU 31 is configured and programmed to repeatedly carry out the processing of generating and transmitting infrastructural information as shown in FIG. 4. The infrastructural information of the subject vehicle is generated and transmitted to the surrounding area by carrying out this processing.

First, time information and orbit information sent out from GPS satellites are acquired through the GPS antenna 29 (S110). Latitude and longitude and traveling direction as the present position of the subject vehicle are determined based on the acquired orbit information (S120). Information on the speed of the subject vehicle, turn signal flasher information, and brake information are acquired through the LAN 25 (S130). ID information stored beforehand in the system control ECU 31 itself is read out (S140). Finally, the pieces of information acquired as above are grouped into one set to generate infrastructural information and the communication control ECU 15 is caused to transmit this information in a set to the surrounding area through the communication antenna 13 (S150).

The thus transmitted infrastructural information is received through the respective communication antennas 13 and stored by the system control ECU 31 of the inter-vehicle communication device 11 equipped in each of surrounding vehicles. All the infrastructural information acquired from other vehicles need not be stored. With respect to information sent from one and the same vehicle, for example, the latest one is sufficient. Even when some information is latest with respect to a vehicle, it is unnecessary if a sufficient time has passed and the information is old.

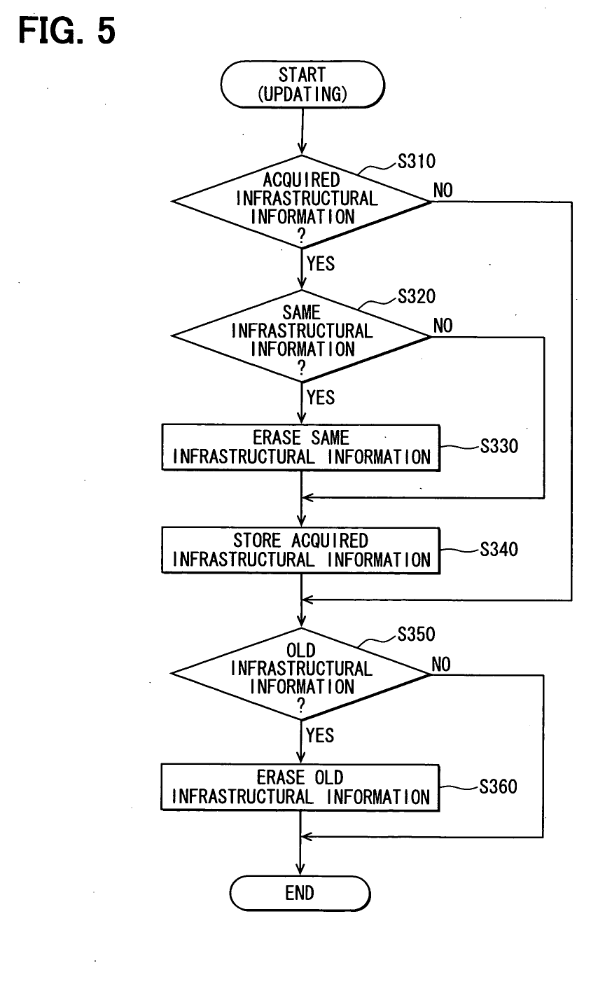

The system control ECU 31 is configured and programmed to discard such unnecessary information as shown in FIG. 5, which illustrates the processing of receiving and updating infrastructural information. This processing is repeatedly carried out almost exclusively by the system control ECU 31.

First, it is checked whether or not infrastructural information has been acquired through the communication antenna 13 (S310). When it is determined that infrastructural information has not been acquired through the communication antenna 13 (No at S310), step S350 is carried out.

Meanwhile, when it is determined that infrastructural information has been acquired through the communication antenna 13 (Yes at S310), it is checked whether or not infrastructural information including the same vehicle ID as the vehicle ID included in the acquired infrastructural information has been already stored in the relevant system control ECU itself (S320). When it is determined infrastructural information including the same vehicle ID as the vehicle ID included in the acquired infrastructural information has been already stored (Yes at S320), the infrastructural information including the same vehicle ID as the vehicle ID included in the newly acquired infrastructural information is erased (S330). Meanwhile, when it is determined that infrastructural information including the same vehicle ID as the vehicle ID included in the acquired infrastructural information has not been stored (No at S320), nothing is done since there is not any object to be erased.

At the next step, the newly acquired infrastructural information is stored (S340). Then it is checked whether or not the time included in the infrastructural information is a predetermined or longer time before the present time (S350), that is, the infrastructural information is old. When it is determined that the time included in the infrastructural information is the predetermined or longer time before the present time (Yes at S350), the infrastructural information including the time the predetermined or longer time before the present time is erased (S360) and the processing of receiving and updating infrastructural information is terminated.

Meanwhile, when it is determined that the time included in the infrastructural information is not the predetermined or longer time before the present time (No at S350), nothing is done since there is not an object to be erased. The processing of receiving and updating infrastructural information is terminated. The infrastructural information illustrated in FIG. 3 is thus updated from time to time in the memory provided in the system control ECU 31 by repeating the above processing of receiving and updating infrastructural information.

Referring back to FIG. 2, the system control ECU 31 incorporated in the inter-vehicle communication device 11 equipped in each vehicle acquires forward vehicle information using the radar 21 and the radar control ECU 23 provided for the inter-vehicle communication device 11 incorporating the system control ECU itself. In FIG. 2, the range (coverage) of the radar 21 equipped in vehicle E is shown as an example. Vehicle A, vehicle B and vehicle D are positioned in this coverage. Information on radar reflected by vehicle A, vehicle B and vehicle D is acquired by the system control ECU 31 equipped in vehicle E through the radar 21 and the radar control ECU 23.

The system control ECU 31 calculates forward vehicle information by its own x-y-coordinate system. This coordinate system is defined as follows: the center of the subject vehicle is taken as the center of coordinates; the direction of entire width is taken as the x-direction; the direction of entire length is taken as the y-direction; and the positive orientation in the y-direction is equivalent to the orientation of the front face of the vehicle.

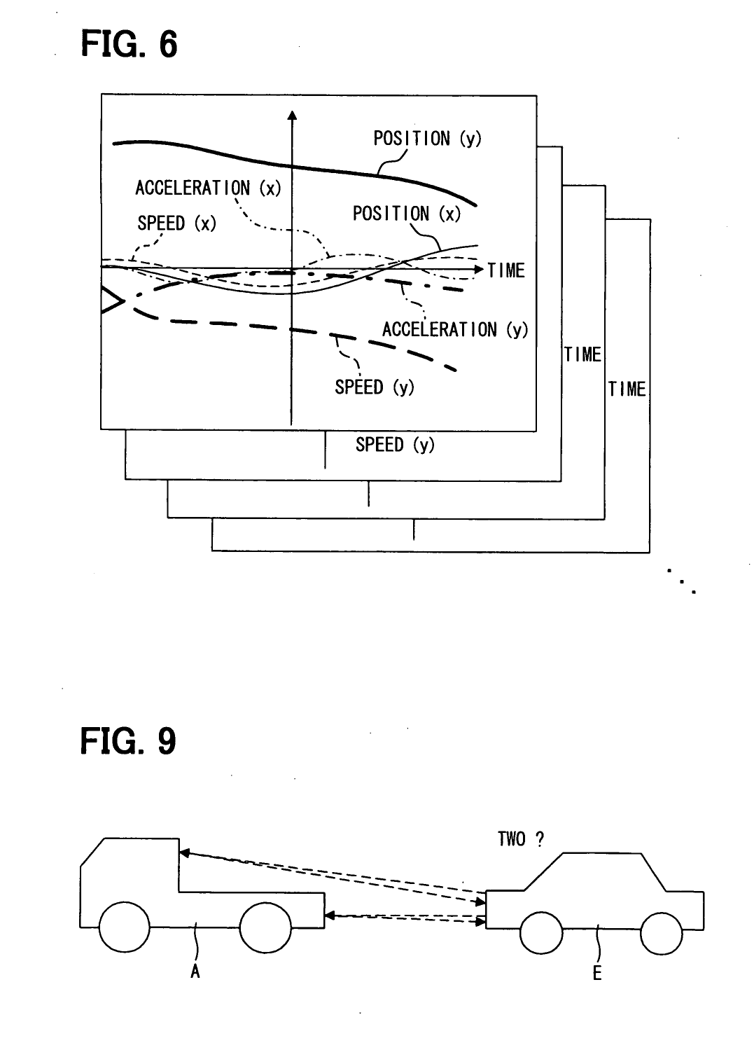

FIG. 6 represents the forward vehicle information of each vehicle in the form of graph. The contents of forward vehicle information include: the x-coordinate and the y-coordinate of the center of the forward vehicle; the speed (in the x-direction) and the speed (in the y-direction) of the forward vehicle relative to the subject vehicle; and the acceleration (in the x-direction) and the acceleration (in the y-direction) of the forward vehicle relative to the subject vehicle. The values of these pieces of information are calculated as functions of time. That is, forward vehicle information is estimation of the position, speed and acceleration of each forward vehicle from past to future with the present at the center.

Forward vehicle information for the period of past time will be referred to as past value; forward vehicle information for the present time will be referred to as present value; and forward vehicle information for the period of future time will be referred to as future value. The system control ECU 31 discards the information of a vehicle that could not be acquired by the radar for a certain period of time.

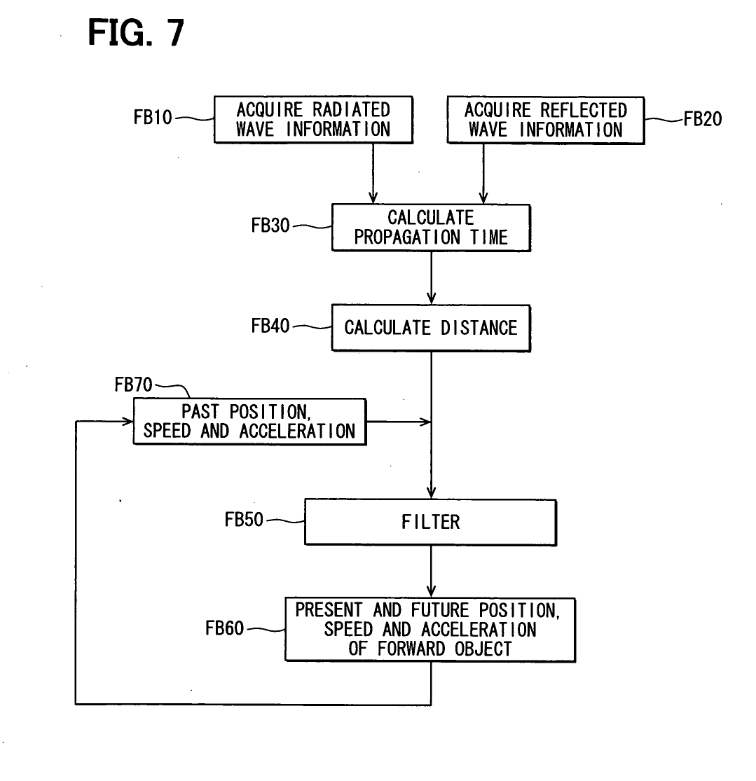

The forward vehicle information is acquired as shown in FIG. 7. This acquisition method is well known and will be only briefly described with reference to FIG. 7, which represents the relation between the individual functions carried out by the system control ECU 31 when forward vehicle information is acquired. The system control ECU 31 carries out computation corresponding to each function in accordance with the relation illustrated in this functional block diagram and thereby acquires the forward vehicle information of each vehicle.

First, information on the phases of radiated waves radiated at predetermined angular intervals and information on the phase of the reflected wave corresponding to each radiated wave are acquired from the radar control ECU 15 (FB10 and FB20). With respect to each angle at which a radiated wave is radiated, the phase difference is acquired from information on two phases and the time of propagation of the radar wave is determined (FB30). The distance to an object that reflected the radiated wave is calculated from this time of propagation (FB40). However, with respect to an angle at which the reflected wave is weak and it is guessed that there is no object in a predetermined distance, distance computation is not carried out.

The distance calculated with respect to each angle and information on the position, speed and acceleration acquired in the past are inputted to a predetermined filter (Kalman filter or the like) (FB50). The following are thereby calculated with respect to each object that reflected the radar wave: the present position, speed and acceleration, and the position, speed and acceleration at each predetermined point of time in the future with the present time taken as the base point.

The calculated position, speed and acceleration are combined with information on the position, speed and acceleration of the object at each predetermined point of time in the past with the present time taken as the base point. The above forward vehicle information is thereby calculated with respect to each object that reflected the radar wave (FB60). The acquired forward vehicle information is stored in correlation with the time when the information was calculated (FB70). The reason which the forward vehicle information is stored in correlation with the time when the information was calculated is as follows: since the infrastructural information also includes time information, time information will be required when the forward vehicle information and the infrastructural information are compared with each other or other like processing is carried out later.

The information stored here is handled as values acquired in the past inputted at FB50 when this functional block is carried out after the lapse of a predetermined time. For the details of this type of technologies, refer to JP 2002-99986 A or U.S. patent application Ser. No. 12/228,135 filed on Aug. 8, 2008.

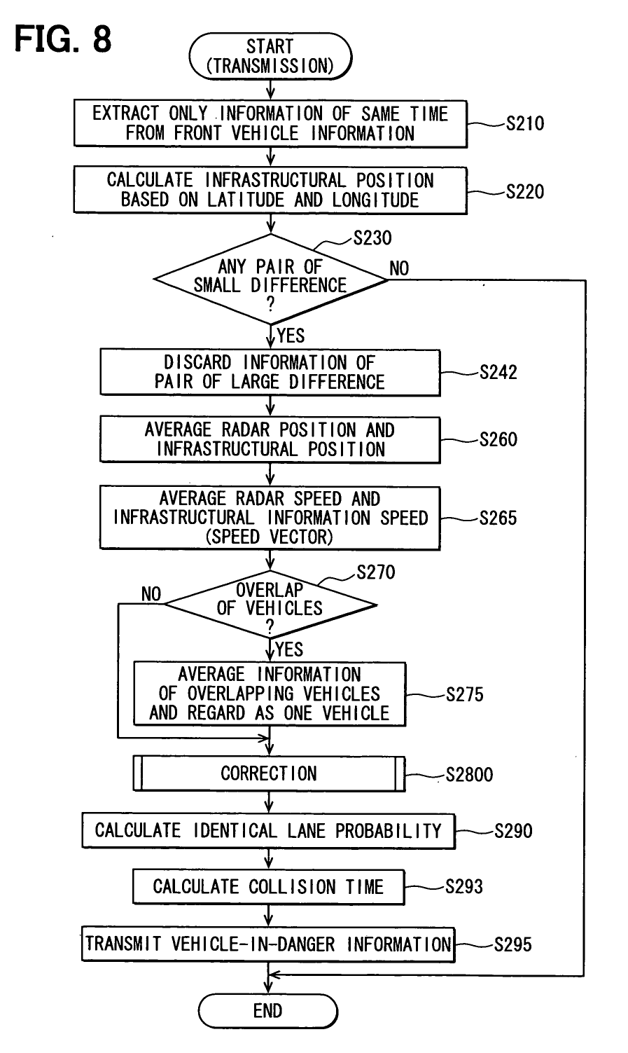

Transmission processing is shown in FIG. 8, which is carried out almost exclusively by the system control ECU 31. In this processing, infrastructural information is corrected with the forward vehicle information. In addition, a vehicle on a potential collision course is identified by the corrected information and the information of the subject vehicle is transmitted to that vehicle.

The execution of this processing is triggered by the system control ECU 31 itself determining that one or more pieces of both forward vehicle information and infrastructural information are stored. It is assumed here as an example that the system control ECU 31 is equipped in vehicle E.

First, the individual pieces of forward vehicle information and the individual pieces of infrastructural information are combined in all the possible pairs. In each pair, only information at the same time as the time information in infrastructural information is extracted from forward vehicle information as a function of time and this extracted information is set as an object to be processed (S210). That is, information at some time is extracted from radar information as a function of time and only the extracted information is taken as the target of the following processing. Here, the time indicated by infrastructural information is taken as the present time. The position indicated by forward vehicle information at this time will be hereafter referred to as “radar position” and the speed indicated by forward vehicle information at this time will be hereafter referred to as “radar speed.”

The processing of step S210 will be described in detail. From the viewpoint of vehicle E described with reference to FIG. 2, there are three vehicles A, B and C indicated by infrastructural information. Hereafter, infrastructural information corresponding to vehicle A will be designated as a; infrastructural information corresponding to vehicle B will be designated as b; and infrastructural information corresponding to vehicle C will be designated as c. It will be assumed that there are four vehicles indicated by forward vehicle information and these vehicles will be respectively designated as x, y, z and w.

It will be assumed that z and w have just come into the radar coverage and their numbers of times of radar acquisition are small. As described before as the background art, the information acquired in such a situation is inferior in reliability. According to the background art, therefore, the information cannot be outputted as the information of a vehicle.

With respect to the vehicles indicated by forward vehicle information, x and y correspond to vehicle A; z corresponds to vehicle B; and w corresponds to vehicle D. This information is intrinsically information that can be acquired only after infrastructural information and forward vehicle information are integrated with each other by subsequent processing. However, it is described first for making the description based on the detailed example clearly understandable.

There are two pieces of forward vehicle information corresponding to vehicle A. This will be described with reference to FIG. 9. FIG. 9 illustrates vehicle A and vehicle E. Radar waves radiated by the radar 21 equipped in vehicle E and reflected waves thereof are indicated by broken lines. When the body or chassis of vehicle A has a large step like a truck, vehicle A may be erroneously recognized as if there are two vehicles. X and y correspond to vehicle A for this reason.

Referring back to the processing of step S210, infrastructural information and forward vehicle information are grouped into 12 pairs, ax, ay, az, aw, bx, by, . . . . In pair ax, for example, the information of x at the same time as the time indicated by a is used. This is the same with the other pairs.

In each pair, the position of the vehicle indicated by infrastructural information is represented by the same x-y coordinate system as that of the radar position (S220). This is done based on the information on latitude and longitude included in the infrastructural information of the subject vehicle and the other vehicles. The position information acquired here will be hereafter referred to as “infrastructural position.”

The difference between the radar position and the infrastructural position is calculated and it is checked whether or not there is any pair with this small difference equal to or smaller than a predetermined threshold value (S230). The purpose of the processing of steps S220 and S230 is to identify which forward vehicle information and which infrastructural information pertain to one and the same vehicle.

When it is determined that there is no pair with the calculated difference in distance equal to or smaller than the predetermined threshold value (No at S230), the transmission processing is directly terminated. Meanwhile, when it is determined that there is a pair with the calculated difference in distance equal to or smaller than the predetermined threshold value (Yes at S230), the following processing is carried out: the pieces of information of the pairs other than the pair with the calculated difference in distance equal to or smaller than the predetermined threshold value are discarded (S242). In the example in FIG. 2, ax, ay, and bz are the relevant pairs. Thus the pieces of information of the other pairs are all discarded.

At this stage, the system control ECU 31 recognizes that x and y are information pertaining to vehicle A and z is information pertaining to vehicle B.

Subsequently, with respect to each pair that has not been discarded, the radar position and the infrastructural position of the pair are averaged (S260). In addition, with respect to each pair, the speed in forward vehicle information and the speed in infrastructural information are averaged (S265). The speed in forward vehicle information is calculated by synthesizing the relative speed (in the x-direction) and the relative speed (in the y-direction) in radar speed.

With respect to speed in infrastructural information, it is required to transform the coordinates in the infrastructural information of the other vehicles beforehand. This is because for averaging, it is required to match the coordinate system of infrastructural information with the coordinate system of forward vehicle information. A detailed computation method is such that: the speed of the subject vehicle is subtracted from the speed of another vehicle corresponding to infrastructural information. At this time, the “speed” indicated by each piece of infrastructural information is taken as the magnitude of each speed and the “traveling direction” indicated by each piece of infrastructural information is taken as the direction of each speed.

In the processing of steps S260 and S265, weight may be added for averaging so that forward vehicle information is reflected better. This is because forward vehicle information is higher in reliability.

It is checked whether or not there is any portion where vehicles overlap each other by a predetermined or more area when the vehicles are disposed in the positions calculated at step S260 (S270). Description will be given to the disposition referred to here. This disposition is two-dimensional and does not include conception in the vertical direction. That is, the disposition means that rectangles analogous to vehicles are placed on a drawing indicating the ground viewed from directly above.

A position acquired at step S260 is taken as the center position of the corresponding rectangle. The “entire length” in infrastructural information is taken as the length of the long sides of the rectangle and the “entire width” in infrastructural information is taken as the length of the short sides of the rectangle. In addition, the direction of the speed (travel) acquired at step S265 is taken as the direction of the long sides of the rectangle. In the processing of step S270, with respect to each pair, it is checked whether or not there are any rectangles that overlap each other by a predetermined or more area when rectangles compared to vehicles are disposed as described above.

When it is determined that there are vehicles that overlap each other by a predetermined or more area when vehicles are disposed in the positions calculated at step S260 (Yes at S270), the following processing is carried out: the vehicles are regarded as one vehicle and the positions acquired at step S260 are averaged with respect to each vehicle that overlaps by a predetermined or more area; with respect to each vehicle that overlaps by a predetermined or more area, the speeds acquired at step S265 are averaged; and the accelerations included in forward vehicle information pertaining to each vehicle that overlaps by a predetermined or more area are averaged. The position, speed and acceleration of the one vehicle are thereby determined (S275).

The purpose of the processing of step S275 is to correct erroneous recognition. When recognition is carried out only from information acquired from the radar 21, vehicle A shown in FIG. 9, for example, is erroneously recognized as two vehicles. In such a case, the information can be corrected by utilizing infrastructural information. However, there is some caution to be exercised at this time. Specifically, only pairs having identical infrastructural information should be regarded as one vehicle. For example, a combination of ax and ay poses no problem. However, a combination of ax and bz and a combination of ay and bz must be avoided even though the distances are close to each other. This is because when infrastructural information differs, the vehicle also differs.

The processing up to this point is carried out on the present values. Subsequently, correction processing is carried out (S2800). This correction processing is carried out to correct the future values of position and speed acquired by the above-described processing by a filter (FB50). As described with reference to FIG. 6 and FIG. 7, future values can be calculated by a conventional technology based on past values and present values. More advantageous effect than with conventional technologies can be acquired just by computing future values based on the present values corrected by the processing up to this point. In this embodiment, these future values are further corrected with traveling information included in infrastructural information.

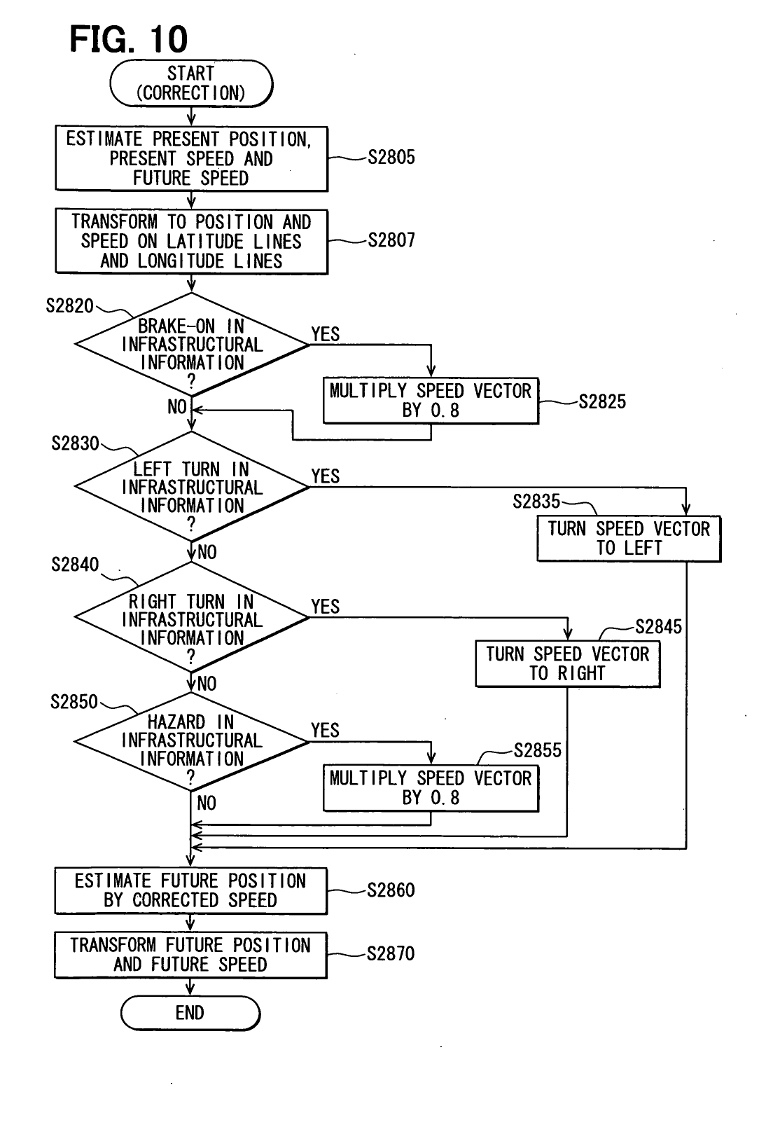

This will be described with reference to FIG. 10. First, with respect to each forward object, values acquired at step S2870 at the previous time or before are taken as input values in place of the values at FB70. Further, the present position acquired by the processing of step S260 this time is taken as the distance to the forward vehicle acquired from the time of propagation of the radar wave. These values are anew inputted to the filter described with reference to the functional block diagram in FIG. 7 and the present position, present speed and future speed are thereby estimated (S2805). That is, the target of this correction processing is pairs addressed at steps S260 to S275 and values acquired just by inputting the above-described information acquired from the radar to the filter are not addressed.

At step S2805, the pieces of information on acceleration at the present time and in the future are also acquired. However, since information on acceleration is not used in the subsequent correction processing, acceleration is not referred to in this description.

The estimated present position, present speed and future speed are transformed to position and speed on the basis of latitude lines and longitude lines (S2807). Specifically, the estimated values are transformed by the infrastructural information of the subject vehicle. That is, the following processing is carried out by using the information on latitude and longitude as the position of the subject vehicle: the position in forward vehicle information acquired on the basis of the subject vehicle is transformed to a position on the basis of latitude and longitude. This is the same with speed.

It is checked whether or not the brake information in infrastructural information indicates ON (S2820). When it is determined that the brake information in infrastructural information indicates ON (Yes at S2820), the following processing is carried out: the magnitude of the vector of the future speed acquired up to this point is multiplied by a constant (for example, 0.8) less than 1 (S2825) and step S2830 is carried out. Meanwhile, when it is determined that the brake information in infrastructural information indicates OFF (No at S2820), step S2830 is carried out.

At step S2830, it is checked whether or not the turn signal flasher information in infrastructural information indicates left turn. When it is determined that the turn signal flasher information in infrastructural information indicates left turn (Yes at S2830), the following processing is carried out: the direction of the vector of the future speed acquired up to this point is rotated to left (counterclockwise) through a predetermined angle (S2835) and step S2860 is carried out. Meanwhile, when it is determined that the turn signal flasher information in infrastructural information does not indicate left (No at S2830), step S2840 is carried out.

At step S2840, it is checked whether or not the turn signal flasher information in infrastructural information indicates right turn. When it is determined that the turn signal flasher information in infrastructural information indicates right (Yes at S2840), the following processing is carried out: the direction of the vector of the future speed acquired up to this point is rotated to right (clockwise) through a predetermined angle (S2845) and step S2860 is carried out. Meanwhile, when it is determined that the turn signal flasher information in infrastructural information does not indicate right (No at S2840), step S2850 is carried out.

At step S2850, it is checked whether or not the turn signal flasher information in infrastructural information indicates hazard. When it is determined that the turn signal flasher information in infrastructural information indicates hazard (Yes at S2850), the following processing is carried out: the magnitude of the vector of the future speed acquired up to this point is multiplied by a constant (for example, 0.8) less than 1 (S2855) and S2860 is carried out. Meanwhile, when it is determined that the turn signal flasher information in infrastructural information does not indicate hazard (No at S2850), step S2860 is carried out.

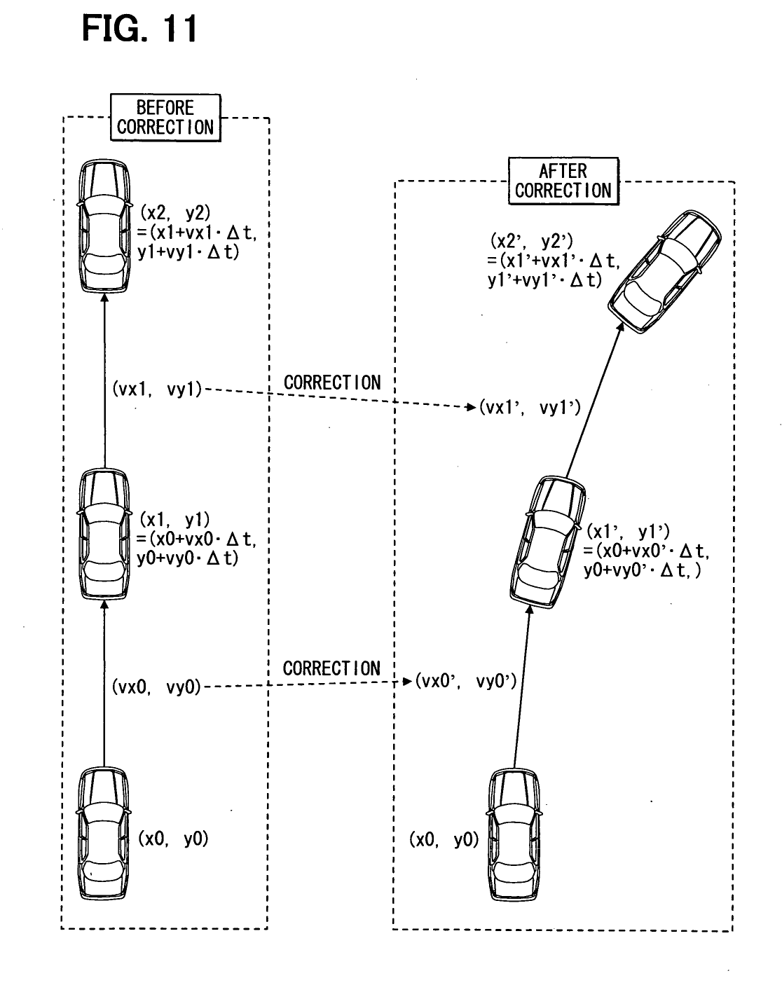

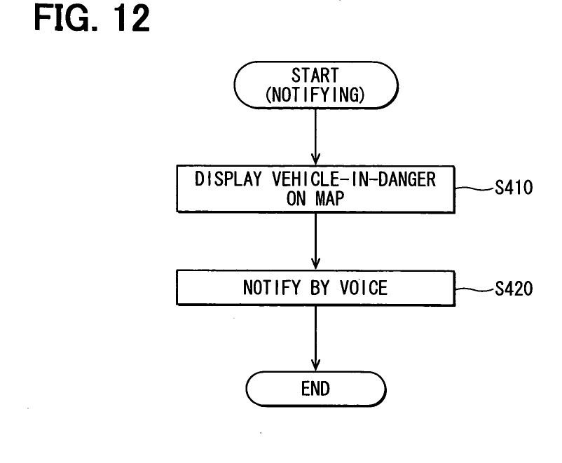

At step S2860, a future position is determined based on the present values of speed acquired by the correction processing up to this point and the position acquired by the processing of step S2807. This method for determining the future position will be described with reference to FIG. 11.

FIG. 11 illustrates determination of the future position by the future speed. Left-side illustration (a) shows how the future position is calculated based on the future speed acquired at step S2807. First, (x0, y0) is taken as the present position and (vx0, vy0) is taken as the present speed. Thus the position (x1, y1) a very short time Δt later is expressed as (x0+vx0·Δt, y0+vy0·Δt). Letting the speed a very short time Δt after the present time be (vx1, vy1), the position another short time Δt later is expressed as (x1+vx1·Δt, y1+vy1·Δt).

Meanwhile, right-side illustration (b) shows the result acquired at step S2860. It will be assumed that the future speed acquired at step S2807 is corrected at steps S2820 to S2855. Specifically, it will be assumed that (vx0, vy0) is corrected to (vx0′, vy0′) and (vx1, vy1) is corrected to (vx1′, vy1′). Thus the position (x1′, y1′) a very short time Δt after the present time is expressed as (x0+vx0′·Δt, y0+vy0′·Δt). Letting the speed a very short time Δt after the present time be (vx1′, vy1′), the position another very short time Δt later is expressed as (x1′+vx1′·Δt, y1′+vy1′·Δt).

Following step S2860, the future position and future speed acquired by the processing up to this point are transformed to those of the coordinate system on the basis of the subject vehicle (S2870). That is, the processing inverse to the processing of step S2807 is carried out. Specifically, the position of another vehicle on the basis of the subject vehicle is determined from the positions of the subject vehicle and the other vehicle acquired on the basis of latitude and longitude. This is the same with speed. Then the correction processing is terminated.

As described above, the values calculated at step S2870 are used at step S2805 in the subsequent and following correction processing. That is, the values acquired as present value and future value are turned into past values with time; therefore, they are handled as past values at step S2805. In addition, with respect to information on acceleration, the values calculated at step S2805 are handled as past values at step S2805 in the subsequent and following processing.

After the correction processing shown in FIG. 10 is carried out, step S290 shown in FIG. 8 is carried out. At this step, the probability of traveling on the same lane (identical lane probability) at each time in the future until a predetermined time later is calculated based on the position information at each time in the future acquired with respect to each vehicle. A detailed method for computing the identical lane probability is known (for example, U.S. Pat. No. 5,710,565 corresponding to JP 08-279099 A). A collision time is calculated with respect to vehicles whose identical lane probability calculated at step S290 is equal to or larger than a predetermined threshold value (S293).

Collision time is the estimated value of a time until the subject vehicle and an object in question will collide with each other. This collision time may be calculated as follows. Time is advanced from the present time by unit time using the position at each time in the future acquired by the correction processing. If there is a time when the distance between the subject vehicle and the forward vehicle becomes smaller than a threshold value, the period of time from the present time to that time can be determined as collision time.

Finally, vehicle-in-danger information is transmitted to a vehicle whose collision time is equal to or smaller than the threshold value through the communication control ECU 15 and the communication antenna 13 (S295). This information includes the position and speed of the subject vehicle relative to that vehicle. Then the transmission processing is terminated. When there is no vehicle whose identical lane probability is equal to or higher than the predetermined threshold value, the processing of step S295 is not carried out and the transmission processing is terminated. The transmission processing is also terminated when there is no vehicle whose collision time is equal to or smaller than the threshold value.

This transmission processing will be briefly summarized. At steps S210 to S275, information on the vehicle position (latitude and longitude), traveling direction and speed indicated by infrastructural information is corrected with forward vehicle information. At step S2800, a future value is estimated based on the corrected present value, turn signal flasher information, and brake information. A vehicle whose collision time is equal to or smaller than a threshold value is identified as a vehicle on the course of a potential collision with the subject vehicle. Then the speed and position of the subject vehicle are transmitted as vehicle-in-danger information to that vehicle.

When the inter-vehicle communication device 11 equipped in the vehicle to which the vehicle-in-danger information was transmitted receives the vehicle-in-danger information, the communication device carries out notification processing shown in FIG. 12.

The execution of this processing (FIG. 12) is triggered by the reception of vehicle-in-danger information and it is carried out almost exclusively by the system control ECU 31 incorporated in the inter-vehicle communication device 11. First, the position included in the vehicle-in-danger information is displayed on the display 35 so that the positional relation between the receiving vehicle and the subject vehicle can be understood. Specifically, the positions of the subject vehicle and the vehicle included in the vehicle-in-danger information are indicated on a map (S410). Information on this positional relation is notified by voice through the speaker 33 (S420). Specifically, the positional relation is classified into eight directions and the most relevant direction is selected and notified. The eight directions are forward, backward, left, right, ahead on the right, ahead on the left, behind on the right and behind on the left. Thereafter, this processing is terminated.

The advantage acquired by each processing described above is as follows: infrastructural information becomes more accurate and inter-vehicle communication for drive assist can be carried out based on the accurate infrastructural information. This will be described based on the example in FIG. 2. If any vehicle is not going to shift lanes, it will be likely that only vehicle A will collide with vehicle E. Therefore, if the collision time between vehicle A and vehicle E is equal to or smaller than a threshold value, information on the position and speed of the subject vehicle is transmitted to vehicle A. Then the driver of vehicle A is notified of the information through the speaker 33 and display 35 equipped in vehicle A.

It will be assumed that the right turn signal flasher of vehicle B is in operation. In this case, it can be guessed that vehicle B is going to cross over into the lane in which vehicle E is traveling. It will be assumed that the future identical lane probability calculated based on this guess increases beyond a threshold value. Thus information on the position and speed of the subject vehicle is transmitted to vehicle B. Then the driver of vehicle B is notified of the information through the speaker 33 and display 35 equipped in vehicle B.

This drive assist cannot be implemented by conventional inter-vehicle communication devices. This is because information acquired by GPS is low in accuracy, and cannot be used to estimate the risk of collision. Even though it is desired to transmit alerting information to the forward vehicle traveling in the same lane, it cannot be learned which vehicle is traveling in the same lane.

In this embodiment, this problem is solved through the utilization of forward vehicle information. Thus it is possible to identify a vehicle on a possible collision course based on accurate information and to transmit the information of the subject vehicle to that vehicle. This brings about profound advantage.

As understood from the foregoing description, the processing of FB10 to FB70 operates as analyzing means; steps S210 to S242 operate as recognizing means; step S260 operates as position correcting means; step S2800 operates as position estimating means; and steps S290 and S293 operate as identifying means. The processing of FIG. 12 operates as notifying means.

The present invention is not limited to the disclosed embodiment but may be implemented in many other ways.

For example, the communication device may be a cellular phone. In this case, the possible targets acquired by the radar include humans, bicycles, motorcycles, four-wheeled vehicles, and the like. When the inter-vehicle communication device 11 equipped in a vehicle determines that there is a possibility of collision, the communication device transmits alerting information to the relevant cellular phone. When the cellular phone receives the information, it notifies the user of the alerting information through the screen and speaker thereof.

This configuration makes it possible to reduce the risk of a cellular phone user having a traffic accident. Some cellular phone users may pay close attention to the display on his/her cellular phone screen or conversation and be oblivious of the risk of collision. The invention is effective in preventing traffic accidents caused in such situations.

What is claimed is:

1. A recognition system comprising:
a communication device having first communicating means configured to wirelessly transmit information on present position thereof to a surrounding area; and
a recognition device having second communicating means configured to receive position information transmitted from the communication device,
wherein the recognition device includes:
analyzing means configured to radiate a radar wave and determine positions of objects based on result of reception of reflected waves that are reflected by the objects;
position acquiring means configured to acquire information of present position of the recognition device;
recognizing means configured to recognize as a nearby device an object among the objects whose position has been determined by the analyzing means based on result of analysis by the analyzing means, the position information received by the second communicating means, and result of acquisition by the position acquiring means; and
position correcting means configured to correct the position information of the nearby device received by the second communicating means based on result of acquisition by the position acquiring means and result of analysis by the analyzing means.

2. The recognition system of claim 1, wherein:
the recognition device is equipped in a movable body and includes identifying means configured to identify a nearby device on a course of a possible collision with the movable body among any nearby devices recognized by the recognizing means;
the second communicating means is configured to transmit information on presence of the movable body to the communication device of the nearby device identified by the identifying means; and
the first communicating means is configured to receive presence information transmitted from the first communication means.

3. The recognition system of claim 2, wherein:
the movable body is a vehicle;
the recognition device includes position estimating means configured to estimate position of the nearby device relative to the vehicle in the future based on the position information corrected by the position correcting means, and identical lane probability computing means configured to compute an identical lane probability, which is a probability that the vehicle and the nearby device will be positioned in one and the same lane in the future, based on the position of the nearby device in the future estimated by the position estimating means; and
the identifying means is configured to identify the nearby device on the course of a possible collision with the vehicle based on result of computation by the identical lane probability computing means.

4. The recognition system of claim 3, wherein:
the identifying means is configured to identify as the nearby device on the course of a possible collision with the vehicle a nearby device which comes close so that distance from the vehicle becomes equal to or smaller than a predetermined threshold value and whose identical lane probability calculated by the identical lane probability computing means is equal to or higher than a predetermined threshold value based on result of estimation by the position estimating means and result of computation by the identical lane probability computing means.

5. The recognition system of claim 2, wherein:
the communication device includes notifying means configured to notify a user thereof presence of a movable body including the second communication means in response to presence information received by the first communication means from the second communication means.

6. The recognition system of claim 5, wherein:
the presence information received from the second communication means includes information on position of the second communication means; and
the notifying means is configured to notify the user of presence of the movable body having the second communication means by at least either of an image and a sound.
